(19) United States
(12) Patent Application Publication
(10) Pub. No.: US 2014/0237379 A1
(43) Pub. Date: Aug. 21, 2014

(54) DISPLAY APPARATUS AND METHOD OF SHARING DIGITAL CONTENT BETWEEN EXTERNAL DEVICES

(71) Applicant: SAMSUNG ELECTRONICS CO., LTD., Suwon-si (KR)

(72) Inventors: Ridhi CHUCH, Noida (IN); Amitoj SINGH, Noida (IN); Snehal DESHPANDE, Noida (IN)

(73) Assignee: SAMSUNG ELECTRONICS CO., LTD., Suwon-si (KR)

(21) Appl. No.: 14/185,373

(22) Filed: Feb. 20, 2014

(30) Foreign Application Priority Data
Feb. 21, 2013 (IN) 746/CHE/2013
Nov. 12, 2013 (KR) 10-2013-0137120

(51) Int. Cl. H04L 29/06; G06F 3/0484

(52) U.S. Cl. CPC H04L 65/403; G06F 3/0484
USPC 715/748

(57) ABSTRACT

A display apparatus and a method of sharing digital content between external devices by using a display apparatus are provided. The method includes: displaying a user interface including a plurality of tabs which respectively correspond to a plurality of external devices connected to the display apparatus; detecting a user operation to select a first external device and a second external device, from among the plurality of external devices, between which a copy operation of the digital content is to be performed; and copying the digital content from the first external device to the second external device, in response to the detection of the user operation.

### CROSS REFERENCE TO RELATED APPLICATIONS

This application claims priority from Indian Patent Application No. 746/CHE/2013, filed on Feb. 21, 2013 in the Indian Patent Office and Korean Patent Application No. 10-2013-0137120 filed on Nov. 12, 2013, in the Korean Intellectual Property Office, the disclosures of which are incorporated herein in by reference, their entireties.

### BACKGROUND

1. Field

Apparatuses and methods consistent with exemplary embodiments relate to electronic devices, and more particularly, to a display apparatus and method of sharing digital content between external devices.

2. Description of the Related Art

Digital content (e.g., music, video or picture) is usually stored in an electronic device (e.g., a flash drive or a smart phone). The digital content may be played on a personal computer (PC). Some home display apparatuses, e.g., a flat television (TV), used to watch TV broadcast and movies also have an extended function of playing digital content from an electronic device. However, a user may use a PC to share digital content from an electronic device with other users and may store and arrange the digital content. In this case, it is recommended that the electronic device is connected to the PC every time digital content is played, which is bothersome to users.

In consideration of the above description, there are demands for an efficient method and system for sharing digital content between external devices by using a display apparatus and for storing and arranging the digital content in the display apparatus.

### SUMMARY

One or more exemplary embodiments provide a display apparatus and a method of sharing digital content between external devices by using a display apparatus.

According to an aspect of an exemplary embodiment, there is provided a method of sharing digital content between external devices in a display apparatus, the method including: displaying a user interface including a plurality of tabs which respectively correspond to a plurality of external devices connected to the display apparatus; detecting a user operation to select a first external device and a second external device, from among the plurality of external devices, between which a copy operation of the digital content is to be performed; and copying the digital content from the first external device to the second external device, in response to the detecting of the user operation.

According to an aspect of another exemplary embodiments, there is provided a display apparatus including: a communication interface configured to perform electronic communication with a plurality of external devices connected to the display apparatus; a memory configured to store instructions; and a processor configured to execute to the instructions to control the display to display a user interface including a plurality of tabs which respectively correspond to the plurality of external devices, detect a user operation to select a first external device and a second external device, from among the plurality of external devices, between which a copy operation of the digital content is to be performed, and copy the digital content from the first external device to the second external device, in response to the detection of the user operation.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a block diagram of an environment to which an exemplary embodiment is applied, wherein various exemplary embodiments may be implemented according to the environment;

FIG. 2 is a block diagram of a flat screen TV according to an exemplary embodiment;

FIG. 3 is a flowchart of a method of sharing digital content between external devices by using a flat screen TV, according to an exemplary embodiment;

FIG. 4 is a perspective view of a flat screen TV according to an exemplary embodiment;

FIGS. 5A to 5C are a perspective view and side views of a data slot connected to a flat screen TV, according to an exemplary embodiment; and

FIGS. 6A to 6F illustrate sharing digital content between external devices by using a flat screen TV, according to exemplary embodiments.

### DETAILED DESCRIPTION OF THE EXEMPLARY EMBODIMENTS

It will be understood that operations of a method and components of a system are shown in the drawings with existing signs, and only relevant details are shown for an understanding of the exemplary embodiments. In addition, the matters which would be obvious to those of ordinary skill in the art may not be disclosed. In the present disclosure, the terms indicating a relationship, such as first, second, and the like, may be used to distinguish one entity from the other entities without unnecessarily suggesting an actual relationship or order between the entities.

Exemplary embodiments provide a display apparatus and a method of sharing digital content between external storage devices. Herein, a flat screen TV is described as an example of the display apparatus.

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

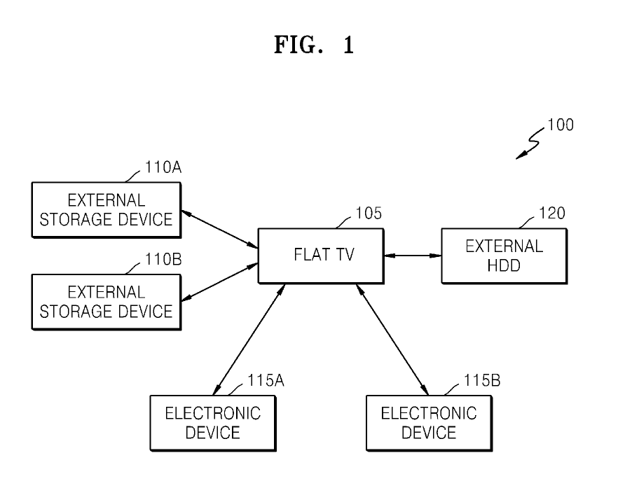

FIG. 1 is a block diagram of an environment 100 to which an exemplary embodiment is applied, wherein various exemplary embodiments may be implemented according to the environment 100.

Referring to FIG. 1, the environment 100 includes a flat screen TV 105, one or more external storage devices (e.g., external storage devices 110A and 110B), one or more electronic devices (e.g., electronic devices 115A and 115B), and an external hard disk drive (HDD) 120. Examples of the one or more external storage devices include a universal serial bus (USB) device, a micro secure digital (SD) card, a mini SD card, a compact flash card, and a high definition multimedia interface (HDMI) card but are not limited thereto. The one or more external storage devices are connected to different slots of the flat screen TV 105. Examples of the slots include a USB slot, a mini USB slot, a micro USB slot, and an HDMI slot but are not limited thereto. The external HDD 120 is included in a data slot, and the data slot is also connected to the flat screen TV 105. Examples of the one or more electronic devices include a digital camera, a pen drive, a card reader, a smart phone, a mobile phone, a personal digital assistant (PDA), a tablet device, and a laptop computer, but are not limited thereto. Herein, an external device may include an external storage device, an electronic device, an external HDD, and the like.

A user may control the one or more electronic devices, the one or more external storage devices, the external HDD 120, and the flat screen TV 105.

The flat screen TV 105 displays a user interface including a plurality of tabs if the one or more external storage devices (e.g., the external storage devices 110A and 110B) or the one or more electronic devices (e.g., the electronic devices 115A and 115B) are connected thereto. A tab corresponds to an external storage device and includes one or more folders. The user may first select a first external storage device and a second external storage device and then perform a copy operation of copying digital content from the first external storage device to the second external storage device. A progressing bar associated with the copy operation may also be displayed on the user interface. The external HDD 120 may store the digital content.

According to one or more exemplary embodiments, a USB hub device may be connected to one (e.g., a USB slot) of the different slots. The USB hub device may convert the USB slot to a multi-USB slot, and accordingly, the user may connect USB-usable electronic devices thereto. The connected electronic devices may be displayed in tab and folder forms on the flat screen TV 105. Herein, the term “tab” is provided on the user interface so as to correspond to each of a plurality of external devices and may be referred to as an “item,” and in response to the user selecting a tab or an item, a data folder included in an external device which corresponds to the selected tab or item may also be displayed.

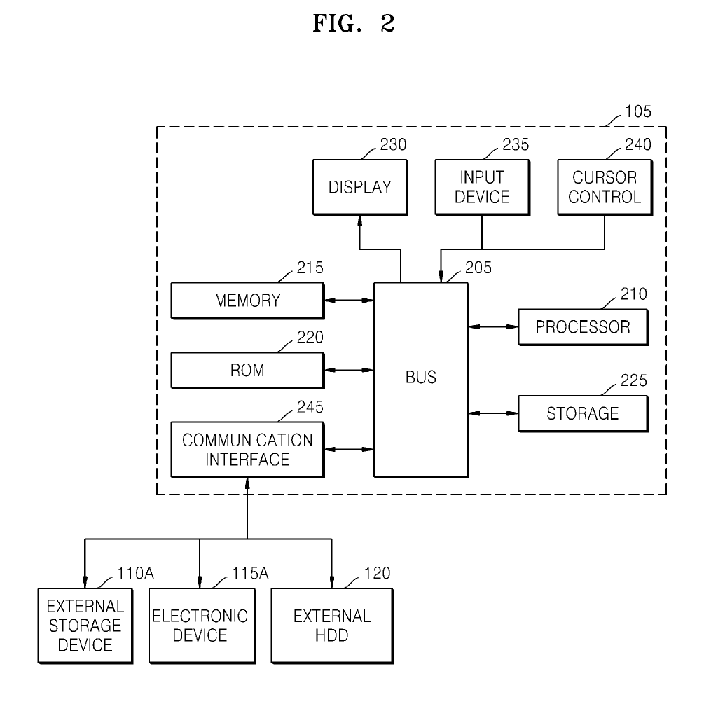

The flat screen TV 105 including a plurality of elements will now be described in detail with reference to FIG. 2.

FIG. 2 is a block diagram of the flat screen TV 105 according to an exemplary embodiment.

The flat screen TV 105 includes a bus 205 or another communication mechanism for communication of information and a processor 210 which is connected to the bus 205 and processes the information. The flat screen TV 105 also includes a memory 215 (e.g., a random access memory (RAM) or another dynamic storage device) connected to the bus 205, and the memory 215 stores information and instructions to be executed by the processor 210. The memory 215 may be used to store temporary variables or other intermediate information, while the processor 210 is executing instructions. The flat screen TV 105 also includes a read only memory (ROM) 220 or another static storage device which is connected to the bus 205 and stores instructions and static information for the processor 210. A storage 225 (e.g., a magnetic disc or an optical disc) is provided and is connected to bus 205 to store information.

The flat screen TV 105 also includes a display 230 connected to the bus 205 to display a plurality of tabs and folders which correspond to a plurality of external storage devices. Examples of the flat screen TV 105 include a liquid crystal display (LCD) TV, a light-emitting display (LED) TV, a plasma TV, an organic light-emitting diode (OLED) TV, and a quantum dot display (QLED) TV but are not limited thereto. An input device 235 having alphanumeric keys and other keys is connected to bus 205 in order to deliver information and a command selection to the processor 210. Another type of user input device is a cursor control 240 (e.g., a mouse, a track ball, or a cursor direction key) for delivering direction information and a command selection to the processor 210 and for controlling a cursor motion on the display 230.

Various exemplary embodiments are associated with the use of the flat screen TV 105 to implement the inventive concept. According to one or more exemplary embodiments, the flat screen TV 105 carries out the technology in response to operations of processor 210 for executing the instructions stored in the memory 215. The instructions may be read from another machine-readable medium (e.g., the storage 225) and stored in the memory 215. The processor 210 performs a process operation by executing the instructions stored in the memory 215.

According to one or more exemplary embodiments, the processor 210 may include one or more processing units for performing one or more functions of the processor 210. The one or more processing units are a hardware circuit substituted for software instructions or used with software instructions in order to carry out a certain function.

The term “machine-readable medium” used herein refers to all media which participates in providing data for a machine to carry out a certain function. In an exemplary embodiment implemented by using the flat screen TV 105, various machine-readable media may, for example, participate to provide instructions for execution to the processor 210. The machine-readable medium may be a volatile or nonvolatile storage medium. The volatile medium includes a dynamic memory, e.g., the memory 215. The nonvolatile medium includes an optical or magnetic disc, e.g., the storage 225. All these media may be tangible so that a physical mechanism for reading instructions into a machine detects instructions stored in a medium.

Typical types of the machine-readable medium are, for example, a floppy disk, a flexible disk, a hard disk, a magnetic tape, and other magnetic media, CD-ROM and other optical media, punchcards, papertape, and other physical media having a pattern of holes, and RAM, programmable ROM (PROM), erasable PROM (EPROM), flash-EPROM, and other memory chips or cartridges.

According to another exemplary embodiment, the machine-readable medium may be a transmission medium, which includes a coaxial cable, a copper wire, and an optical fiber, or a transmission medium, which includes a wire including the bus 205. The transmission medium may have a form of an acoustic or optical wave, such as a radio wave and a wave generated during infrared data communication. Examples of the machine-readable medium may include a carrier wave to be described below and an arbitrary medium readable by the flat screen TV 105, but are not limited thereto. For example, instructions may be stored in a magnetic disc of a remote computer at an initial stage. The remote computer may load the instructions to a dynamic memory thereof and transmit the instructions over a telephone line by using a modem. A local modem (not shown) of the flat screen TV 105 may receive data over the telephone line and may use an infrared transmitter (not shown) to convert the received data into an infrared signal. An infrared detector (not shown) may receive the data carried on the infrared signal, and a circuit may provide the data through the bus 205. The bus 205 transfers the data to the memory 215, and the processor 210 searches for and executes the instructions from the memory 215. The instructions received to the memory 215 may be selectively stored in the storage 225 before or after the execution of the instructions by the processor 210. All these media may be tangible so that the instructions stored in the media are detected by a physical mechanism for reading the instructions by a machine.

The flat screen TV 105 also includes a communication interface 245 connected to the bus 205. The communication interface 245 provides bidirectional communication for connecting the flat screen TV 105 to external devices, e.g., the external storage device 110A, the electronic device 115A, and the external HDD 120. For example, the communication interface 245 may be an integrated services digital network (ISDN) card or a modem to provide data communication access to a corresponding type of telephone line. As another example, the communication interface 245 may be a local area network (LAN) card for providing data communication access to a compatible LAN. In all these implementation examples, the communication interface 245 transmits and receives an electrical signal, an electromagnetic signal, or an optical signal, and these signals carry a digital data stream which indicates various types of information.

The processor 210 of the flat TV 105 may operate to display a user interface if one or more external storage devices or one or more electronic devices are connected to the flat screen TV 105. A plurality of tabs may be displayed on the user interface. A tab corresponds to an external storage device and may include one or more folders. The processor 210 may detect a user operation to select a first external device and a second external device between which a copy operation of the digital content is to be performed, and copy the digital content from the first external device to the second external device, in response to the detection of the user operation. The processor 210 may also display a progress bar associated with the copy operation on the user interface. The external HDD 120 may store the digital content.

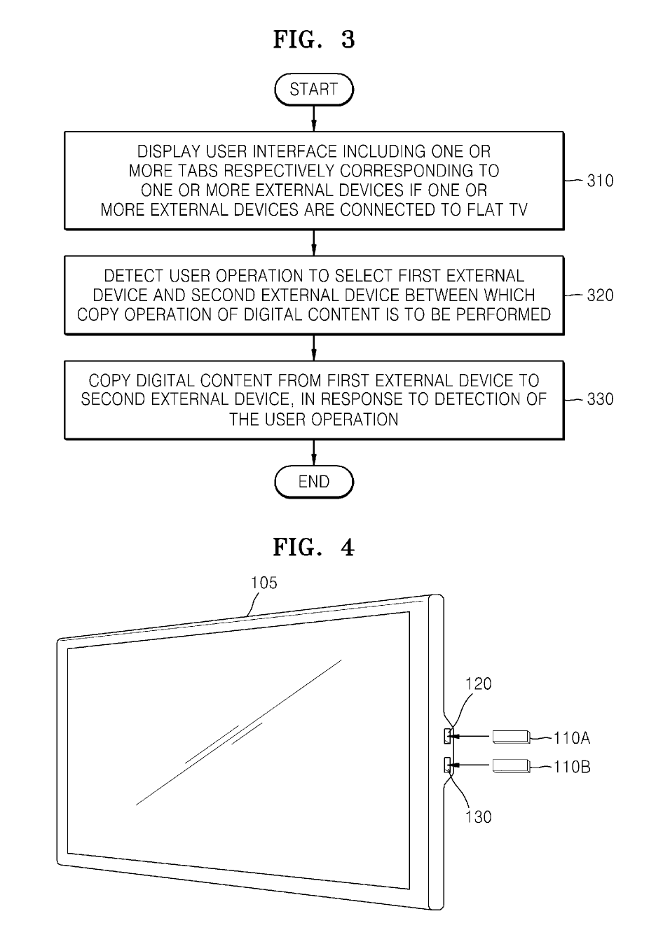

FIG. 3 is a flowchart of a method of sharing digital content between external devices by using a flat screen TV (e.g., the flat screen TV 105), according to an exemplary embodiment.

A user may watch the flat screen TV while sharing the digital content. Examples of the digital content include pictures, music, videos and movies, but are not limited thereto.

In operation 310, in response to one or more external devices being connected to the flat screen TV, a user interface is displayed which includes one or more tabs respectively corresponding to the one or more external devices. The one or more external devices may be the one or more electronic devices, the one or more external storage devices, the external HDD 120, and the like, shown in FIG. 1. The one or more external devices are connected to one or more slots provided in the flat screen TV.

FIG. 4 is a perspective view of the flat screen TV 105 including slots 120 and 130 to which the external storage devices 110A and 110B are to be connected, according to an exemplary embodiment.

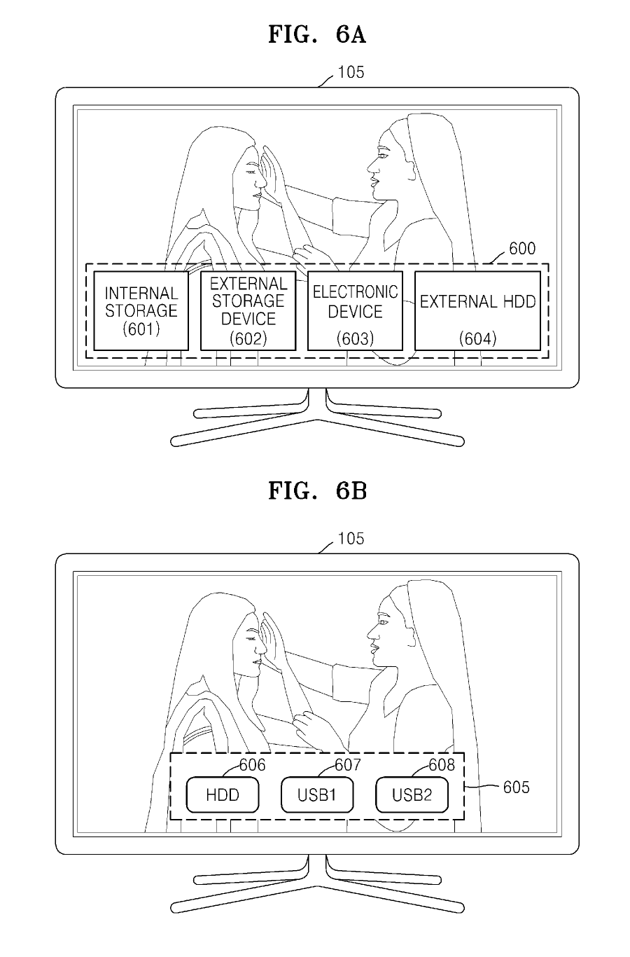

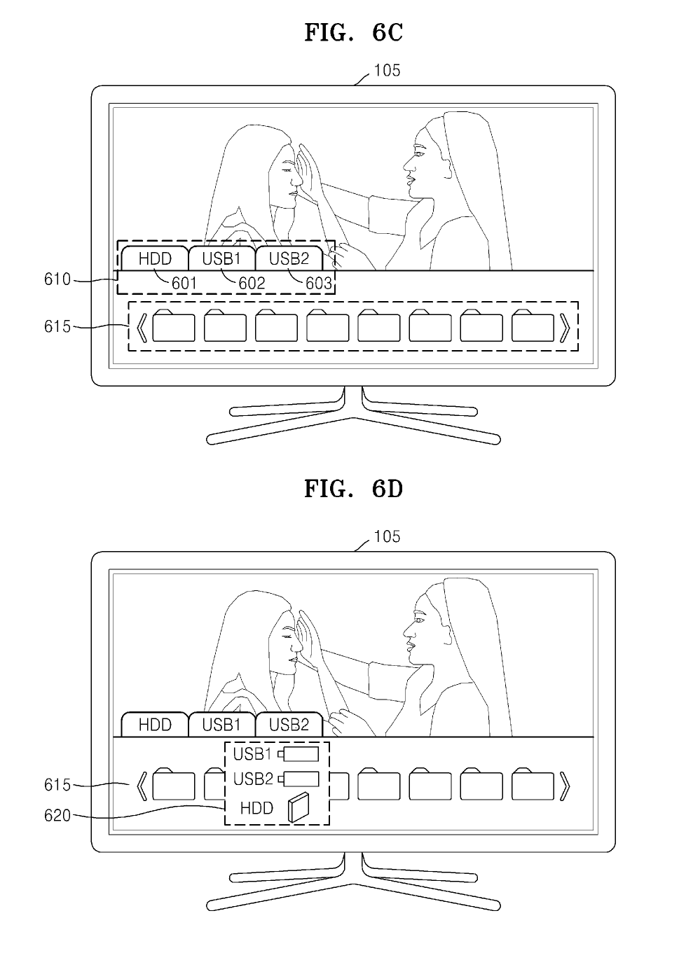

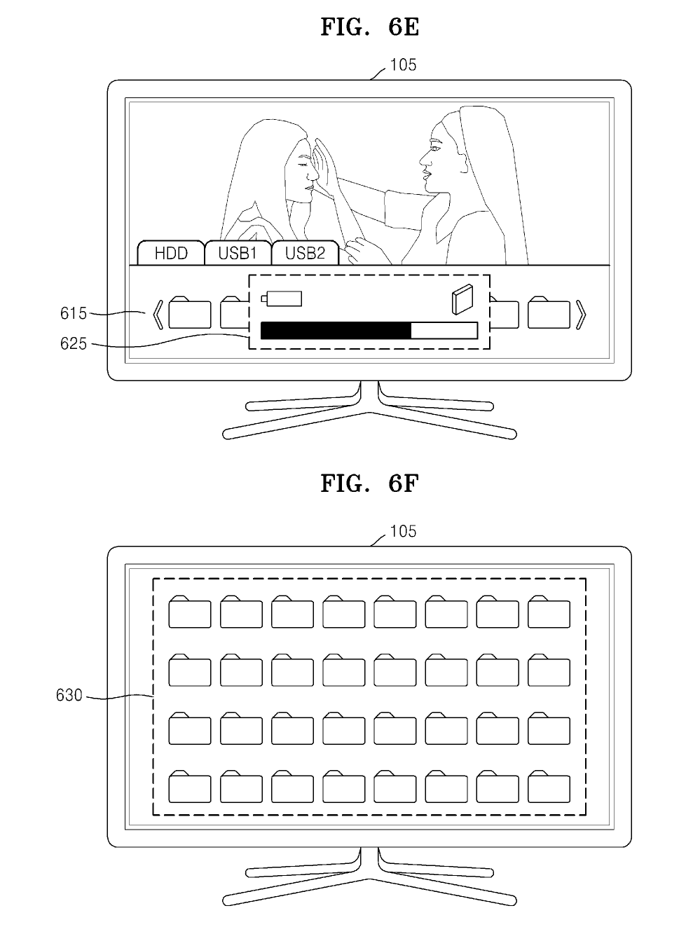

FIG. 6A shows an example where a user interface 600 including tabs 602 to 604 corresponding to external devices, e.g., an external storage device, an electronic device, and an external HDD, is displayed on the flat screen TV 105 in response to these external devices being connected to the flat screen TV 105, according to an exemplary embodiment. Referring to FIG. 6A, the user interface 600 includes a tab 601 which corresponds to an internal storage, the tab 602 which corresponds to the external storage device, the tab 603 which corresponds to the electronic device, and the tab 604 which corresponds to the external HDD. As shown in FIG. 6A, the tabs 602 to 604 which correspond to the external devices are included in the user interface 600 displayed in response to the external devices being connected to the flat screen TV 105, and in this case, it will be understood by those of ordinary skill in the art that whether the tab 601 which corresponds to the internal storage in the flat screen TV 105 is also provided, may vary according to the exemplary embodiments.

In addition, the user may connect the one or more external devices to the one or more slots in order to share the digital content between the one or more external devices while watching audio/video through the flat screen TV. In this case, in order to not disturb the user watching the TV, the displayed user interface may be provided on a portion of a screen. If the user interface is displayed only on the lower portion of the screen of the flat screen TV as shown in FIG. 6A, the user may share the digital content between the one or more external devices without disturbing the user watching the TV.

FIG. 6B illustrates a user interface 605 displayed when an external HDD, a first external storage device (USB1) and a second external storage device (USB2) are connected to the flat screen TV 105, according to another exemplary embodiment.

Referring to FIG. 6B, the user interface 605 includes a tab 606 which corresponds to the external HDD, a tab 607 which corresponds to the USB1, and a tab 608 which corresponds to the USB2.

In addition, each of the one or more tabs included in the user interface corresponds to an external device and may include one or more folders. FIG. 6C illustrates folders 615 which correspond to a tab selected on a user interface 610 including tabs 601 to 603, according to an exemplary embodiment.

In operation 320, the user operation to select a first external device and a second external device between which a copy operation of the digital content is to be performed, is detected. For example, the user may perform a copy operation of copying the digital content from a first external storage device to a second external storage device. An option of the copy operation may be provided to the user, and the user selects the first external storage device and the second external storage device. FIG. 6D illustrates allowing the user to select a copy operation, according to an exemplary embodiment. A dropdown menu 620 is provided to the user with the option of the copy operation, and the user may select the first external storage device and the second external storage device.

In operation 330, the digital content is copied from the first external device to the second external device, in response to the detection of the selected user copy operation.

According to one or more exemplary embodiments, the digital content may be displayed on the flat TV from any one of the first external device and the second external device.

According to one or more exemplary embodiments, the digital content may be stored in an external HDD (e.g., the external HDD 120). The external HDD may be included in a data slot connected to the flat screen TV 105.

According to another exemplary embodiment, the digital content may be stored in an internal memory (e.g., the memory 215).

According to one or more exemplary embodiments, a progressing bar associated with the copy operation may be displayed on the user interface. FIG. 6E illustrates a progress bar 625 according to an exemplary embodiment. The progress bar 625 disappears when a copy operation ends.

According to one or more exemplary embodiments, a full screen mode 630 of folders as shown in FIG. 6F may be displayed on the user interface.

According to one or more exemplary embodiments, the flat screen TV includes an application which is previously installed in an internal memory (e.g., the memory 215) and is updatable using an external storage device. Examples of the previously installed application include a game, a religious calendar, and a screen saver, but are not limited thereto.

According to one or more exemplary embodiments, the flat screen TV includes an integrated pen drive which functions as an internal memory or as a simple pen drive.

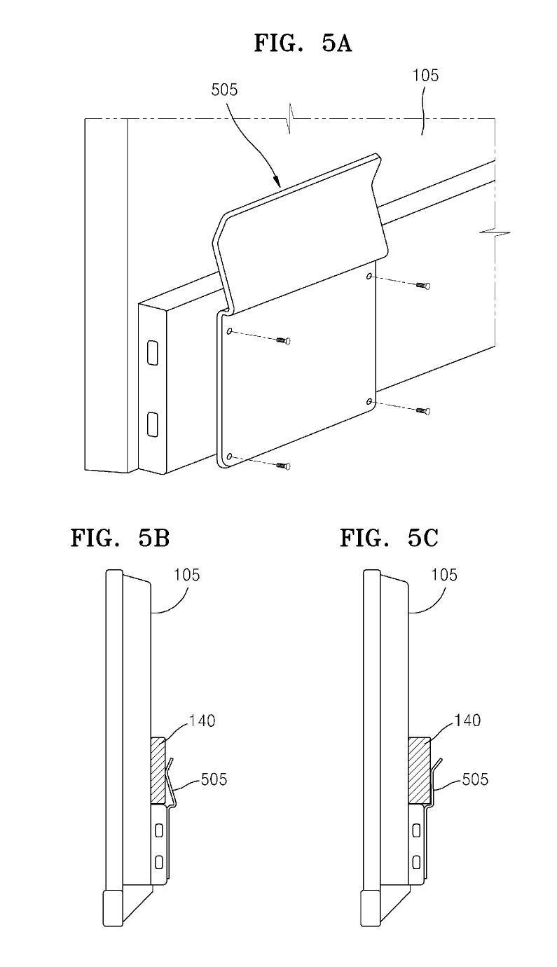

FIG. 5A illustrates a data slot 505 connected to the flat screen TV 105, according to an exemplary embodiment. The data slot 505 is adjustable to meet a thickness of the external HDD 120 or another electronic device, as shown in FIGS. 5B and 5C. According to one or more exemplary embodiments, the data slot 505 is a flexible plastic panel on the rear of the flat screen TV 105.

As described above, according to the one or more of the above exemplary embodiments, digital content may be shared between external storage devices by using a flat screen TV. Therefore, a user may transmit digital content from one external storage device to another external storage device without using a PC, thereby reducing time, enabling multitasking, and providing easy use to users in a variety of age groups. In addition, a data slot supporting an external HDD or another electronic device is provided to the flat screen TV.

The exemplary embodiments can also be embodied as computer-readable codes on a non-transitory computer-readable recording medium. The computer-readable recording medium is any data storage device that can store data which can be thereafter read by a computer system. Examples of the computer-readable recording medium include ROM, RAM, CD-ROMs, magnetic tapes, floppy disks, optical data storage devices, and the like. The computer-readable recording medium can also be distributed over network coupled computer systems so that the computer-readable code is stored and executed in a distributed fashion.

In addition, other embodiments of the present invention can also be implemented through computer-readable code/instructions in/on a medium, e.g., a computer-readable storage medium, to control at least one processing element in order to implement any of the above-described exemplary embodiments. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bit stream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of sharing digital content between external devices in a display apparatus, the method comprising:
displaying a user interface including a plurality of tabs which respectively correspond to a plurality of external devices connected to the display apparatus;
detecting a user operation to select a first external device and a second external device, from among the plurality of external devices, between which a copy operation of the digital content is to be performed; and
copying the digital content from the first external device to the second external device, in response to the detecting the user operation.

2. The method of claim 1, wherein the plurality of tabs comprise a plurality of folders.

3. The method of claim 2, further comprising displaying the user interface which includes a full screen mode of the plurality of folders.

4. The method of claim 1, further comprising displaying the user interface which includes a progress bar associated with the copy operation.

5. The method of claim 1, wherein the first and second external devices are connected to the display apparatus while another content is being displayed on the display apparatus.

6. The method of claim 1, wherein the displaying the user interface comprises displaying the user interface on a portion of a screen of the display apparatus while another content is displayed on another portion of the screen of the display apparatus.

7. The method of claim 1, further comprising displaying the digital content on the display apparatus from one of the first external device and the second external device.

8. The method of claim 1, further comprising storing the digital content in an external hard disk drive (HDD),
wherein the external HDD is included in a data slot connected to the display apparatus.

9. The method of claim 1, wherein the display apparatus comprises at least one application which is previously installed in an internal memory and is updated using at least one of the plurality of external devices, and a plurality of applications which are installed by the user using at least one of the plurality of external devices.

10. A display apparatus comprising:
a display;
a communication interface configured to perform communication with a plurality of external devices connected to the display apparatus;
a memory configured to store instructions; and
a processor configured to execute to the instructions to:
control the display to display a user interface including a plurality of tabs which respectively correspond to the plurality of external devices,
detect a user operation to select a first external device and a second external device, from among the plurality of external devices, between which a copy operation of digital content is to be performed, and
copy the digital content from the first external device to the second external device, in response to the detection of the user operation.

11. The display apparatus of claim 10, further comprising:
a plurality of slots configured to accommodate the plurality of external devices; and
a data slot supporting an external hard disk drive (HDD).

12. The display apparatus of claim 10, wherein the plurality of tabs comprise a plurality of folders.

13. The display apparatus of claim 10, wherein the processor is configured to control the display to display the user interface which includes a full screen mode of the plurality of folders is provided.

14. The display apparatus of claim 10, wherein the processor is configured to control the display to display the user interface which includes a progress bar associated with the copy operation.

15. The display apparatus of claim 10, wherein the first and second external devices are connected to the display apparatus while another content is being displayed by the display.

16. The display apparatus of claim 10, wherein the processor is configured to control the display to display the user interface on a portion of a screen of the display while displaying another content on another portion of the screen of the display.

17. The display apparatus of claim 10, wherein the digital content is displayed on the display from one of the first external device and the second external device.

18. The display apparatus of claim 10, wherein the display apparatus comprises at least one application which is previously installed in an internal memory and is updated using at least one of the external devices, and a plurality of applications which are installed by the user using at least one of the plurality of external devices.

19. A non-transitory computer-readable storage medium having stored therein program instructions, which when executed by a computer, cause the computer to perform a method of sharing digital content between external devices in a display apparatus, the method comprising:
displaying a user interface including a plurality of tabs which respectively correspond to a plurality of external devices connected to the display apparatus;
detecting a user operation to select a first external device and a second external device, from among the plurality of external devices, between which a copy operation of the digital content is to be performed; and
copying the digital content from the first external device to the second external device, in response to the detection of the user operation.

20. A display apparatus comprising:
a plurality of slots configured to accommodate a plurality of external devices;
a communication interface configured to perform electronic communication with the plurality of external devices accommodated in the plurality of slots; and
a processor configured to:
display a user interface including a plurality of tabs which correspond to the plurality of external devices,
detect a user operation to select a first external device and a second external device, from among the plurality of external devices, between which a copy operation of the digital content is to be performed, and
copy the digital content from the first external device to the second external device, in response to the detection of the user operation.
